(19) United States
(12) Patent Application Publication
(10) Pub. No.: US 2026/0187364 A1
(43) Pub. Date: Jul. 2, 2026

(54) METHOD AND APPARATUS WITH LANGUAGE INPUT PROCESSING

(71) Applicant: SAMSUNG ELECTRONICS CO., LTD., Suwon-si (KR)

(72) Inventors: Cheolhyoung LEE, Suwon-si (KR); Seongmin OK, Suwon-si (KR)

(73) Assignee: SAMSUNG ELECTRONICS CO., LTD., Suwon-si (KR)

(21) Appl. No.: 19/316,161

(22) Filed: Sep. 2, 2025

(30) Foreign Application Priority Data
Dec. 30, 2024 (KR) 10-2024-0200335

(51) Int. Cl. G06F 40/216; G06F 40/284

(52) U.S. Cl. CPC G06F 40/216; G06F 40/284

(57) ABSTRACT

A processor-implemented method includes generating a token sequence by preprocessing input data, generating first probability data comprising probability values for candidate tokens by inputting the token sequence to a generative language model (GLM), wherein the first probability data comprises a probability value for a special token, generating second probability data by adjusting a probability value for one or more of the candidate tokens based on a frequency of each of tokens comprised in the token sequence, and determining, among the candidate tokens, a target token to be combined with the token sequence based on the second probability data, wherein the probability value for the special token is excluded from the adjusting such that the probability value for the special token comprised in the first probability data is the same as a probability value for the special token comprised in the second probability data.

### CROSS-REFERENCE TO RELATED APPLICATIONS

This application claims the benefit under 35 USC § 119(a) of Korean Patent Application No. 10-2024-0200335, filed on Dec. 30, 2024 in the Korean Intellectual Property Office, the entire disclosure of which is incorporated herein by reference for all purposes.

### BACKGROUND

### 1. Field

The following description relates to a method and apparatus with language processing.

### 2. Description of Related Art

Natural language processing (NLP) may utilize a generative language model (GLM) to perform optimal decision-making in response to the requirements of a user. A GLM may train large-scale input data and generate a natural processing result based on the context of given input data. A GLM may output probability values for candidate tokens that are likely to appear next based on given input data.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes generating a token sequence by preprocessing input data, generating first probability data comprising probability values for candidate tokens by inputting the token sequence to a generative language model (GLM), wherein the first probability data may include a probability value for a special token, generating second probability data by adjusting a probability value for one or more of the candidate tokens based on a frequency of each of tokens comprised in the token sequence, and determining, among the candidate tokens, a target token to be combined with the token sequence based on the second probability data, wherein the probability value for the special token is excluded from the adjusting such that the probability value for the special token comprised in the first probability data is the same as a probability value for the special token comprised in the second probability data.

The generating of the second probability data may include, for each of the candidate tokens matching a respective token comprised in the token sequence, generating a frequency of the candidate token by extracting the frequency of the respective token comprised in the token sequence.

The generating of the second probability data may include, for each of the candidate tokens matching the respective token comprised in the token sequence, adjusting the probability value for the candidate token comprised in the first probability data to be smaller as the frequency of the candidate token matching the respective token comprised in the token sequence increases.

The generating of the second probability data may include, for each of the candidate tokens matching the respective token comprised in the token sequence, adjusting the probability value for the candidate token comprised in the first probability data inversely proportional to the frequency of the candidate token.

The generating of the second probability data may include generating the second probability data by adjusting, among the candidate tokens, a probability value for one or more of remaining candidate tokens, excluding the special token, based on the frequencies of the tokens comprised in the token sequence.

The special token may include any one or any combination of any two or more of a token indicating an end of a sequence, a token indicating an end of a document, a token indicating an end of text, a token indicating an end of a turn, and a token indicating an end of a task.

Probability values for one or more designated candidate tokens among the candidate tokens comprised in the second probability data may be the same as probability values for the one or more designated candidate tokens comprised in the first probability data.

The generating of the second probability data may include generating the second probability data by adjusting, among the candidate tokens, a probability value for one or more of remaining candidate tokens, excluding the special token and the one or more designated candidate tokens, based on the frequency of the each token comprised in the token sequence.

Probability values for one or more designated candidate tokens among the candidate tokens comprised in the second probability data may be smaller than probability values for the one or more designated candidate tokens comprised in the first probability data.

The generating of the second probability data may include generating the second probability data by adjusting, among the candidate tokens, a probability value for one or more of remaining candidate tokens, excluding the special token, based on the frequency of the each token comprised in the token sequence.

In one or more general aspects, a non-transitory computer-readable storage medium may store code that, when executed by one or more processors, configures the one or more processors to perform any one, any combination, or all of operations and/or methods disclosed herein.

In one or more general aspects, an apparatus includes one or more processors configured to generate a token sequence by preprocessing input data, generate first probability data comprising probability values for candidate tokens by inputting the token sequence to a generative language model (GLM), wherein the first probability data may include a probability value for a special token, generate second probability data by adjusting a probability value for one or more of the candidate tokens based on a frequency of each token comprised in the token sequence, and determine, among the candidate tokens, a target token to be combined with the token sequence based on the second probability data, wherein the probability value for the special token is excluded from the adjusting such that the probability value for the special token comprised in the first probability data is the same as a probability value for the special token comprised in the second probability data.

For the generating of the second probability data, the one or more processors may be configured to, for each of the candidate tokens matching a respective token comprised in the token sequence, generate a frequency of the candidate token by extracting the frequency of the respective token comprised in the token sequence.

For the generating of the second probability data, the one or more processors may be configured to, for each of the candidate tokens matching the respective token comprised in the token sequence, adjust the probability value for the candidate token comprised in the first probability data to be smaller as the frequency of the candidate token matching the respective token comprised in the token sequence increases.

For the generating of the second probability data, the one or more processors may be configured to generate the second probability data by adjusting, among the candidate tokens, a probability value for one or more of remaining candidate tokens, excluding the special token, based on the frequencies of the tokens comprised in the token sequence.

The special token may include any one or any combination of any two or more of a token indicating an end of a sequence, a token indicating an end of a document, a token indicating an end of text, a token indicating an end of a turn, and a token indicating an end of a task.

Probability values for one or more designated candidate tokens among the candidate tokens comprised in the second probability data may be the same as probability values for the one or more designated candidate tokens comprised in the first probability data.

For the generating of the second probability data, the one or more processors may be configured to generate the second probability data by adjusting, among the candidate tokens, a probability value for one or more of remaining candidate tokens, excluding the special token and the one or more designated candidate tokens, based on the frequency of the each token comprised in the token sequence.

Probability values for one or more designated candidate tokens among the candidate tokens comprised in the second probability data may be smaller than probability values for the one or more designated candidate tokens comprised in the first probability data.

For the generating of the second probability data, the one or more processors may be configured to generate the second probability data by adjusting, among the candidate tokens, a probability value for one or more of remaining candidate tokens, excluding the special token, based on the frequency of the each token comprised in the token sequence.

Other features and aspects will be apparent from the following detailed description, the drawings, and the claims.

### BRIEF DESCRIPTION OF THE DRAWINGS

FIG. 1 illustrates an example of a language processing system.

FIG. 2 illustrates an example of operations of a language processing method.

FIG. 3 illustrates an example of determining a target token using a language processing apparatus.

FIG. 4 illustrates an example of obtaining second probability data.

FIG. 5 illustrates an example of obtaining second probability data.

FIG. 6 illustrates an example of configurations of a language processing apparatus.

Throughout the drawings and the detailed description, unless otherwise described or provided, the same drawing reference numerals may be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

Although terms such as “first,” “second,” and “third,” or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but is used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on,” “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” to specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which the present disclosure pertains and after an understanding of the present disclosure. Terms, such as those defined in commonly used dictionaries, should be construed to have meanings matching with contextual meanings in the relevant art and the present disclosure, and are not to be construed to have an ideal or excessively formal meaning unless otherwise defined herein. The use of the term “may” herein with respect to an example or embodiment, e.g., as to what an example or embodiment may include or implement, means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment,” and “one or more examples” has a same meaning as “in one or more embodiments”).

Hereinafter, the examples are described in detail with reference to the accompanying drawings. When describing the examples with reference to the accompanying drawings, like reference numerals refer to like components and a repeated description related thereto will be omitted.

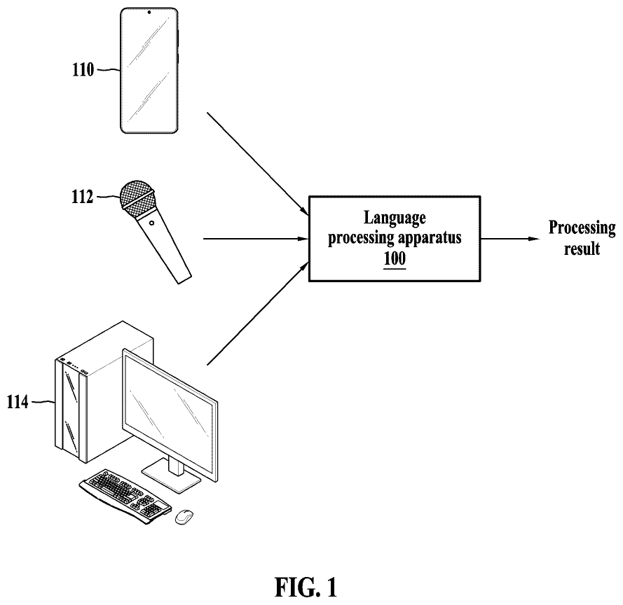

FIG. 1 illustrates an example of a language processing system.

Referring to FIG. 1, a language processing apparatus 100 may output a processing result based on various types of input data. The input data may include various forms, such as text, code, images, and/or speech, but is not limited thereto. In response to the language processing apparatus 100 receiving a request signal included in the input data, the language processing apparatus 100 may execute a generative language model (GLM) to perform tasks such as translation, summarization, and/or text generation. The processing result may include various forms such as text, code, images, and/or speech. The language processing apparatus 100 may be used in, for example, an application programming interface (API) call system, a multi-modal model, an autonomous driving system, a medical system, artificial intelligence (AI), a translation and interpretation system, a speech recognition home appliance, and navigation.

Image data input through a smartphone 110 may be processed by the language processing apparatus 100, and text corresponding to the image data may be generated based on the processed result. The text generated in response to the image data may correspond to the processing result output from the language processing apparatus 100. Speech data input through a microphone 112 may be translated into a target sentence through the language processing apparatus 100. The target sentence may be a result of the translation of the speech data and may correspond to the processing result output from the language processing apparatus 100. The language processing apparatus 100 may be applied to a dialogue system or a question-answering system that provides an answer to data input by a user. The language processing apparatus 100 may generate a target sentence corresponding to the input data in a question-answering system or a dialogue system. Text data input through a computer 114 may output a target sentence, which is a processing result, through the language processing apparatus 100. In other non-limiting examples, the language processing apparatus 100 may be or include the smartphone 110, the microphone 112, and/or the computer 114.

The language processing apparatus 100 may generate a processing result according to input data by using the GLM. The GLM may be an AI model used in natural language processing (NLP), which may perform the function of understanding the context of the input data based on trained data and generating natural text corresponding to the input data. The GLM may be trained through a process of determining the difference between a predicted value and an actual value through a loss function by using a large-scale tokenized text dataset as an input and adjusting parameters through an optimization algorithm. For example, the GLM may include a generative pre-trained transformer (GPT) but is not limited thereto. The language processing apparatus 100 may generate a token sequence by preprocessing the input data. The token sequence may refer to a sequence of tokens in a form that may be input to the GLM. A token may include a word, a sub-word, a character, a grapheme, a consonant, a vowel unit, and/or any combination thereof. When the sub-word is re-divided into a semantic unit in a word, the sub-word may refer to the semantic unit. The input data may be converted into the token sequence in a form that may be input to the GLM, and based on the token sequence, the GLM may predict a probability value for each of a plurality of candidate tokens to be output following the token sequence. The candidate tokens may refer to all possible tokens that may be output following the token sequence. The language processing apparatus 100 may obtain (e.g., determine) frequencies of the candidate tokens matching each token by extracting a frequency of each token included in the token sequence. The language processing apparatus 100 may adjust the probability values for the candidate tokens obtained from the GLM based on the frequency of each token included in the token sequence.

The language processing apparatus 100 may adjust the probability values for the candidate tokens to be small with respect to candidate tokens having a high frequency such that a token that is the same as each token included in the token sequence is not repeatedly output. Adjusting the probability values for any candidate tokens to be small may be described as a type of penalty process that lowers the probability that any candidate tokens are to be output following the token sequence. The language processing apparatus 100 may adjust the probability values for the candidate tokens to be high with respect to candidate tokens having a low frequency. Adjusting the probability values for any candidate tokens to be high may be described as a type of reward process that increases the probability that any candidate tokens are to be output following the token sequence. The language processing apparatus 100 may determine a target token to be combined with the token sequence based on the adjusted probability values for the candidate tokens. The determined target token may be output as part of the processing result.

The language processing apparatus 100 may immediately terminate an output of the processing result when, among the candidate tokens, a special token indicating the end of various processes is determined to be the target token. For example, the special token may include an end-of-sequence (EOS) token indicating the end of a sequence. In response to the determining of the EOS token indicating the end of the sequence, the language processing apparatus 100 may end the output of the processing result, such that the EOS token may not be repeatedly output. All methods of imposing a penalty to avoid the same token being repeatedly output may not impose a penalty on the EOS token that is not repeatedly output. Imposing a penalty on any token may refer to reducing a probability value in which any token may be determined to be a target token or transforming a linked logit value such that the probability value may be reduced. When the sum of the probability values for the candidate tokens is a specified value (e.g., 1), and when a penalty is imposed on any candidate tokens, probability values for other candidate tokens on which a penalty is not imposed may increase. When a penalty is not imposed on the EOS token indicating the end of a sequence, a probability value for the EOS token may increase when a penalty is imposed on any token. When a typical method and apparatus increases the probability value for the EOS token indicating the end of a sequence, the EOS token may be determined too early to be the target token, and in this case, the generation of the processing result may be terminated too early (e.g., before an accurate sequence has been determined).

The special token, such as the EOS token indicating the end of a sequence, may be the last determined target token in the output processing result, so the special token may be treated as an exception from subjects on which a penalty is imposed to prevent the same token from being repeatedly output. As a solution to the problem of a typical method described above, a method of one or more embodiments may impose a penalty on the candidate tokens, excluding the special token, such that the same token is not output repeatedly while the probability value for the special token indicating the end of a process is fixed. The language processing apparatus 100 of one or more embodiments may preserve the length of the processing result generated by fixing the probability value for the special token and may suppress the generation of repeated tokens. The language processing apparatus 100 of one or more embodiments may provide an expected processing result with a sufficient length while reducing the time and cost consumed to reduce the loss and distortion of information that may occur due to the reduced length of the output processing result and to prevent an output of repeated tokens.

The language processing apparatus 100 may impose a penalty on the candidate tokens, excluding the special token and some designated candidate tokens, such that the same token is not repeatedly output while probability values for some candidate tokens, which are additionally designated according to the situation or environment of the user, are fixed, in addition to the special token. The language processing apparatus 100 may output the processing result that is suitable for the purpose of the user while preserving the length of the processing result by additionally fixing the probability values for some candidate tokens corresponding to a specific domain according to the purpose of use of the GLM.

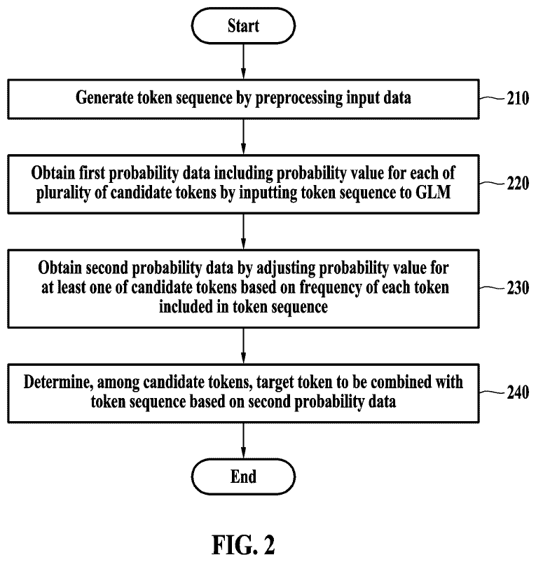

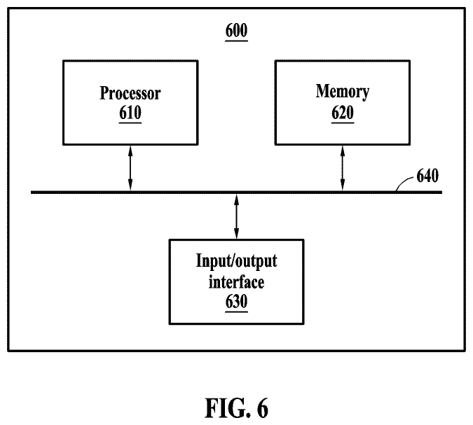

FIG. 2 illustrates an example of operations of a language processing method. Operations 210 to 240 of FIG. 2 may be performed in the order and manner shown. However, the order of one or more of the operations may be changed, one or more of the operations may be omitted, two or more of the operations may be performed in parallel or simultaneously, and/or other operations may be additionally performed without departing from the spirit and scope of the example embodiments described herein. The operations of the language processing method may be performed by a language processing apparatus (e.g., the language processing apparatus 100 of FIG. 1 and a language processing apparatus 600 of FIG. 6).

In operation 210, the language processing apparatus may generate a token sequence by preprocessing input data. The process of preprocessing the input data may be described as a process of converting the input data input by a user into a form that may be input to a GLM. The input data may include a data type such as natural language, code, images, and/or speech. The language processing apparatus may generate a sequence of embedding vectors in a form that may be input to the GLM by preprocessing the input data. The token sequence or the sequence of embedding vectors may refer to a prefix that is input to the GLM. The prefix may refer to data for the GLM to understand the context of the input data provided by the user or to use as an initial condition for sentence generation.

In operation 220, the language processing apparatus may obtain (e.g., generate) first probability data including a probability value for each of a plurality of candidate tokens by inputting the token sequence to the GLM. As the token sequence is input to the GLM, the GLM may predict the probability value for each of the candidate tokens output following the token sequence. The GLM may determine the probability values for the candidate tokens by using a function that converts or maps a logit value to a probability value. The GLM may determine logit values for the candidate tokens and may convert the determined logit values into a probability value between 0 and 1. The function that converts or maps a logit value to a probability value may be, for example, but is not limited thereto, a SoftMax function, a Sparsemax function, an Entmax function, a SoftMax with temperature function, and/or any combination thereof. The logit value may be determined according to the relationship between an internal weight of the GLM and the token sequence that is input to the GLM.

The candidate tokens may include a special token indicating the end of a process. When the candidate tokens include the special token, the first probability data may include a probability value for the special token. The special token may include at least one of a token indicating the end of a sequence, a token indicating the end of a document, a token indicating the end of text, a token indicating the end of a turn, and/or a token indicating the end of a task. For example, the token indicating the end of a sequence may include <\s>, <eos>, and <end>. The token indicating the end of a document may include <EOD> and <|endofdocuments|>. The token indicating the end of text may include <|endoftext|> and <|end_of_text|>. The token indicating the end of a turn may include <|im_end|>, <|endofturn|>, and <|eot_id|>. The token indicating the end of a task may include <|end_of_messages|> and <|eom_id|>.

In operation 230, the language processing apparatus may obtain second probability data by adjusting a probability value for at least one of the candidate tokens based on a frequency of each token included in the token sequence.

The language processing apparatus may obtain frequencies of the candidate tokens matching each token by extracting the frequency of each token included in the token sequence. The language processing apparatus may extract the frequency of each token included in the token sequence by determining how often each token appears in the token sequence. The language processing apparatus may obtain frequency data including the frequency of each of the candidate tokens based on the result obtained by extracting the frequency of each token. Among the candidate tokens, the frequency may be determined high when the candidate tokens more often match each token included in the token sequence (e.g., match each token included in the token sequence a greater number of times) and the frequency may be determined low when the candidate tokens less often match or do not match each token included in the token sequence (e.g., match each token included in the token sequence a fewer number of times).

The language processing apparatus may adjust the probability values for the candidate tokens to be small with respect to candidate tokens having a high frequency in the frequency data such that the same token as each token included in the token sequence is not repeatedly output. The language processing apparatus may adjust the probability values for the candidate tokens included in the first probability data to be smaller as the frequencies of the candidate tokens matching each token included in the token sequence increase. The candidate tokens having a high frequency in the obtained frequency data may have a smaller logit value or probability value as the frequency increases. The possibility that the candidate tokens are to be selected as the target tokens may decrease when the probability values for the candidate tokens decrease.

The language processing apparatus may adjust probability values for candidate tokens having a low frequency in the frequency data to be high. The language processing apparatus may adjust the probability values for the candidate tokens to be high with respect to the candidate tokens having a low frequency in the frequency data such that the same token as each token included in the token sequence is not repeatedly determined to be a target token. For example, the language processing apparatus may adjust the probability values for the candidate tokens included in the first probability data to be higher as the frequencies of the candidate tokens matching each token included in the token sequence decrease. The candidate tokens having a low frequency in the obtained frequency data may have a higher logit value or probability value as the frequency decreases. The possibility that the candidate tokens are to be selected as the target tokens may increase when the probability values for the candidate tokens increase.

The language processing apparatus may obtain the second probability data by adjusting, among the candidate tokens, a probability value for at least one of the remaining candidate tokens, excluding the special token, based on the frequency of each token included in the token sequence. The probability value for the special token included in the second probability data may be the same as a probability value for the special token included in the first probability data. The language processing apparatus may fix the probability value for the special token and adjust the probability values for the remaining candidate tokens, excluding the probability value for the special token. When the language processing apparatus adjusts the probability values for the candidate tokens having a high frequency to be small, the probability values for the candidate tokens having a low frequency may be adjusted to be relatively large. Since the sum of the probability values for the candidate tokens having a low frequency and the probability values for the candidate tokens having a high frequency is the same prior and in response to adjusting the probability values, the probability values for the candidate tokens having a high frequency may become relatively small when the probability values for the candidate tokens having a low frequency increase. The language processing apparatus of one or more embodiments may prevent the same token from being output repeatedly and may provide the processing result with a sufficient length to the user by maintaining the probability value for the special token and increasing the probability values for the candidate tokens having a low frequency in the frequency data.

The language processing apparatus may obtain the second probability data by adjusting, among the candidate tokens, a probability value for at least one of the remaining candidate tokens, excluding the special token and some designated candidate tokens, based on the frequency of each token included in the token sequence. The probability values for some designated candidate tokens among the candidate tokens included in the second probability data may be the same as probability values for the some designated candidate tokens included in the first probability data. In addition to fixing a probability value for a special token indicating the end of a process, the probability values for some candidate tokens among the candidate tokens may be additionally fixed depending on the user environment. For example, some designated candidate tokens may include a token including a meaning expressed in languages (e.g., English or Chinese) that the user does not understand or a token including a meaning expressed in terms (e.g., technical terms) that are difficult for the user to understand. The language processing apparatus may fix the probability values for the special token and some designated candidate tokens and may adjust the probability values for the remaining candidate tokens, excluding the probability values for the special token and some designated candidate tokens. Since the probability values for the candidate tokens having a high frequency are adjusted to be smaller as the frequency increases, the probability values for the candidate tokens having a low frequency may be adjusted to be relatively large. The language processing apparatus of one or more embodiments may prevent the same token from being output repeatedly and may provide the processing result considering the user environment while maintaining the generation length of the processing result by maintaining the probability values for the special token and some designated candidate tokens and increasing the probability values for the candidate tokens having a low frequency in the frequency data.

The probability values for some designated candidate tokens among the candidate tokens included in the second probability data may be smaller than the probability values for the some designated candidate tokens included in the first probability data. In addition to fixing a probability value for a special token indicating the end of a process, the probability values for some candidate tokens among the candidate tokens may be additionally adjusted to be small depending on the user environment. The language processing apparatus may adjust the probability values for the remaining candidate tokens, excluding the probability values for the special token and some designated candidate tokens, while fixing the probability value for the special token and adjusting the probability values for some designated candidate tokens to be small. The probability values for the candidate tokens, which less match or do not match each token included in the token sequence, may be adjusted to be relatively large. The language processing apparatus of one or more embodiments may prevent the same token from being output repeatedly and may provide the processing result considering the user environment while maintaining the generation length of the processing result by maintaining the probability value for the special token, decreasing the probability values for some designated candidate tokens, and increasing the probability values for the candidate tokens having a low frequency in the frequency data.

Among the candidate tokens included in the second probability data, the probability values for the remaining candidate tokens, excluding some designated candidate tokens, may be higher than the probability values for the remaining candidate tokens, excluding some designated candidate tokens included in the first probability data. The language processing apparatus may adjust the probability value for the second probability data to be higher than the probability value for the first probability data with respect to the remaining candidate tokens, excluding some designated candidate tokens. For example, when the user designates candidate tokens in English as some candidate tokens, the probability value for the second probability data with respect to candidate tokens in Korean, excluding some candidate tokens in English, may increase compared to the probability value for the first probability data.

In operation 240, the language processing apparatus may determine, among the candidate tokens, a target token to be combined with the token sequence based on the second probability data.

The language processing apparatus may determine, among the candidate tokens, the target token to be combined with the token sequence by performing decoding according to the second probability data. Through various decoding algorithms, the language processing apparatus may determine the target token from the probability values for the candidate tokens included in the second probability data. For example, the language processing apparatus may determine a candidate token with the highest probability value in the second probability data to be the target token, which is the final processing result. The language processing apparatus may provide the determined target token to the user as a processing result. The processing result may be visually provided through a display or audibly provided through a speaker.

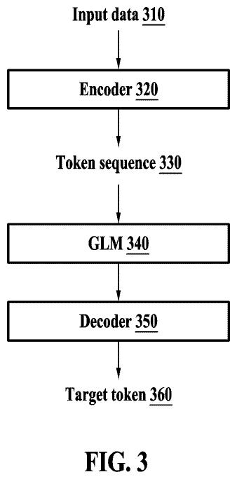

FIG. 3 illustrates an example of determining a target token using a language processing apparatus.

A language processing apparatus (e.g., the language processing apparatus 100 of FIG. 1 and the language processing apparatus 600 of FIG. 6) may include configurations of an encoder 320, a GLM 340, and a decoder 350, but at least one of the configurations of the encoder 320 and the decoder 350 may be implemented as a configuration integrated with the GLM 340. The encoder 320, the GLM 340, and the decoder 350 may be implemented as a single neural network or may be based on separate neural networks. For example, the neural network may include a deep neural network (DNN), a recurrent neural network (RNN), and/or a recurrent deep neural network (RDNN).

The language processing apparatus may obtain a token sequence 330 from input data 310 by using the encoder 320. The input data 310 may be obtained through various input/output interfaces, and the input data 310 obtained through various input/output interfaces may be transmitted to the language processing apparatus. The encoder 320 may convert the input data 310 into data in a form that may be input to the GLM 340. The encoder 320 may convert the input data 310 in the form of text into the token sequence 330 or convert a token included in the token sequence 330 into a high-dimensional embedding vector. For example, the encoder 320 may include bidirectional encoder representations from transformers (BERT) that bidirectionally process the input data 310 in the form of text and generate an embedding vector reflecting context information of words included in the text.

The language processing apparatus may obtain first probability data including probability values for candidate tokens from the token sequence 330 by using the GLM 340. The token sequence 330 may include context information obtained by the GLM 340 by using the encoder 320 to initially generate a sentence. The token sequence 330 may include the context information obtained by using the encoder 320 and include a target token 360 determined up to the previous time step by using the decoder 350. The GLM 340 may predict the probability values for the candidate tokens at each time step based on the token sequence 330 updated to the target token 360 that is determined so far by the decoder 350, including the token sequence 330 obtained by the encoder 320.

The language processing apparatus may obtain second probability data by adjusting a probability value for at least one of the candidate tokens based on a frequency of each token included in the token sequence 330. A probability value for a special token included in the second probability data may be the same as a probability value for the special token included in the first probability data.

The language processing apparatus may determine the target token 360 from the second probability data by using the decoder 350. The decoder 350 may determine the target token 360 among the candidate tokens based on the information obtained from the encoder 320 and the GLM 340 at each time step. The decoder 350 may determine the target token 360 by being dependent on the token sequence 330 that is determined up to the previous time step. The target token 360 determined by using the decoder 350 may be combined with the token sequence 330 obtained by using the encoder 320 and may be used as an input of the GLM 340.

The decoder 350 may determine the target token 360 based on a probability distribution for the candidate tokens or a logit value before being converted into the probability distribution. For example, a decoding algorithm may include a greedy search that determines a single candidate token with the highest probability value to be the target token 360, a beam search that determines the target token 360 that is optimal by simultaneously considering various candidate tokens, top-k sampling that ignores the remaining candidate tokens by only considering candidate tokens with the top k probability values, top-p sampling that only considers candidate tokens with a cumulative probability value exceeding p, temperature sampling that determines the target token 360 that is optimal by adjusting the probability distribution of the candidate tokens, and/or the like.

The language processing apparatus may terminate the generation of the target token 360 and terminate an output of the processing result when the target token 360 corresponds to an EOS token indicating the end of a sequence. When the target token 360 does not correspond to the EOS token, the language processing apparatus may output the determined target token 360 as part of the processing result and may update the token sequence 330 at each time step based on the target token 360.

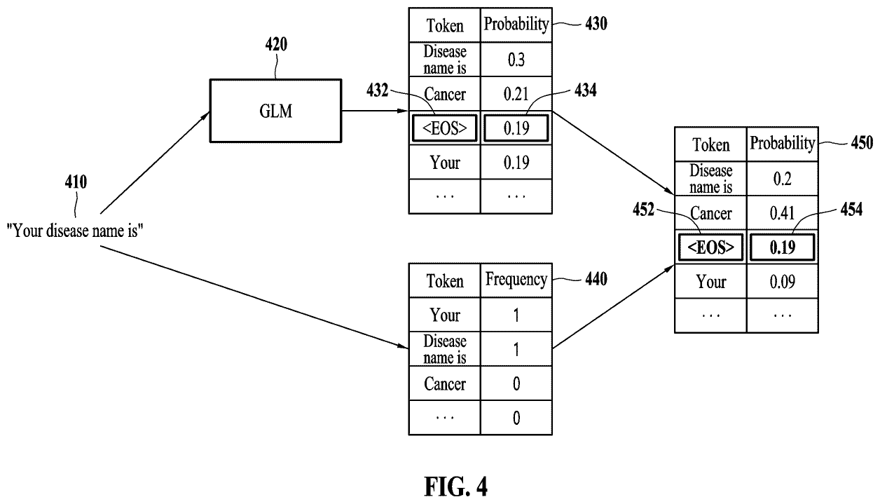

FIG. 4 illustrates an example of obtaining second probability data.

A language processing apparatus (e.g., the language processing apparatus 100 of FIG. 1 and the language processing apparatus 600 of FIG. 6) may obtain first probability data 430 including probability values for a plurality of candidate tokens by inputting a token sequence 410 to a GLM 420. The GLM 420 may determine the probability values for the candidate tokens based on the token sequence 410 that is input. The first probability data 430 may refer to the probability values for the candidate tokens determined by the GLM 420. The GLM 420 may assign high probability values to the most appropriate candidate tokens that follow the token sequence 410 in a given context from the token sequence 410. The sum of the probability values for the candidate tokens included in the first probability data 430 may be 1.

For example, the candidate tokens may include tokens of “your,” “disease name is,” “cancer,” and an EOS token. A probability value for the candidate token “your” included in the first probability data 430 may be 0.19, a probability value for the candidate token “disease name is” may be 0.3, a probability value for the candidate token “cancer” may be 0.21, and a probability value 434 for an EOS token 432 may be 0.19.

The language processing apparatus may obtain frequency data 440 including frequencies of the candidate tokens matching each token by extracting a frequency of each token included in the token sequence 410. For example, the language processing apparatus may extract the frequencies of the tokens “your” and “disease name is” included in the token sequence 410 “your disease name is,” and based on the extracted frequency of each token, the language processing apparatus may obtain, among the candidate tokens, the frequencies of the candidate tokens “your” and “disease name is” matching each token as 1.

The language processing apparatus may obtain second probability data 450 by adjusting a probability value for at least one of the candidate tokens based on the frequency of each token included in the token sequence 410. The language processing apparatus may adjust the probability values for the candidate tokens included in the first probability data 430 to be smaller as the frequencies of the candidate tokens included in the frequency data 440 increase. For example, the language processing apparatus may adjust the probability values for the candidate tokens “your” and “disease name is,” which have relatively high frequencies, to be smaller than the probability value for the candidate token “cancer,” which has a low frequency. This process may be described as a type of penalty process to prevent the same token from being output repeatedly.

The language processing apparatus may obtain the second probability data 450 by adjusting, among the candidate tokens, a probability value for at least one of the remaining candidate tokens, excluding a special token, based on the frequency of each token included in the token sequence 410. The second probability data 450 may be obtained based on the first probability data 430 and the frequency data 440. The sum of the probability values for the candidate tokens included in the second probability data 450 may be 1. The second probability data 450 may be obtained by fixing the probability value 434 for the EOS token 432 in the first probability data 430 and adjusting the probability value for at least one of the remaining candidate tokens, excluding the EOS token 432. The language processing apparatus may adjust the probability value for at least one of the remaining candidate tokens, excluding the EOS token 432, such that a probability value 454 for an EOS token 452 included in the second probability data 450 is the same as the probability value 434 for the EOS token 432 included in the first probability data 430.

For example, the probability value for the candidate token “your” included in the second probability data 450 may be 0.09, the probability value for the candidate token “disease name is” may be 0.2, the probability value for the candidate token “cancer” may be 0.41, and the probability value 454 for the EOS token 452 may be 0.19. Comparing the first probability data 430 with the second probability data 450, it may be seen that the probability value for the candidate token “cancer” to be output following the token sequence 410 “your disease name is” increases from 0.21 to 0.41, the probability value for the candidate token “your” decreases from 0.19 to 0.09, and the probability value for the candidate token “disease name is” decreases from 0.3 to 0.2, while the probability value for the EOS token remains unchanged as 0.19. As a result, the probability value 454 for the EOS token 452 included in the second probability data 450 may be the same as the probability value 434 for the EOS token 432 included in the first probability data 430.

The language processing apparatus may lower the probability that the same token is repeated and determined to be a target token by adjusting the probability values for the candidate tokens matching each token included in the token sequence 410 to be small. For example, when the token sequence 410 “your disease name is” is input to the GLM 420, instead of repeating the output of the same token, such as “your,” “disease name is,” “disease name is,” “disease name is,” “ . . . ,” etc., the language processing apparatus may determine the candidate token “cancer” having the highest probability value in the second probability data 450 to be the target token. In addition, as the probability value 454 for the EOS token 452 included in the second probability data 450 is fixed, the probability that the EOS token 452 is determined to be the target token may be maintained, and as the probability that the EOS token 452 indicating the end of a sequence is determined to be the target token is maintained, the length of the output processing result may be maintained.

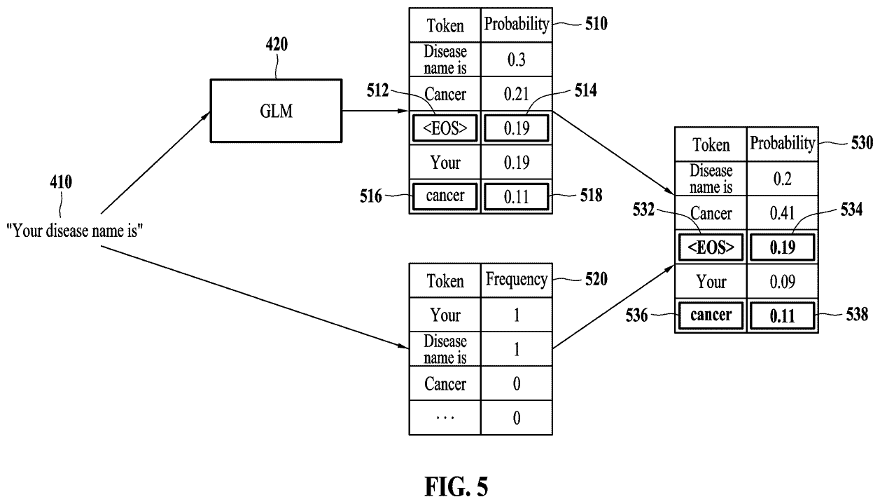

FIG. 5 illustrates an example of obtaining second probability data.

A language processing apparatus (e.g., the language processing apparatus 100 of FIG. 1 and the language processing apparatus 600 of FIG. 6) may obtain first probability data 510 including probability values for a plurality of candidate tokens by inputting the token sequence 410 to the GLM 420. The first probability data 510 may refer to the probability values for the candidate tokens determined by the GLM 420. The sum of the probability values for the candidate tokens included in the first probability data 510 may be 1.

For example, the candidate tokens may include tokens of “your,” “disease name is,” and “cancer,” and an EOS token. A probability value for the candidate token “your” included in the first probability data 510 may be 0.19, a probability value for the candidate token “disease name is” may be 0.3, a probability value for the candidate token “cancer” may be 0.21, a probability value 514 for an EOS token 512 may be 0.19, and a probability value 518 for a candidate token “cancer” 516 may be 0.11. Here, the candidate token “cancer” 516 may be in a language different than a language of the remaining candidate tokens in the first probability data 510 (e.g., the candidate token “cancer” 516 may be the same word as, but in a language different than, the candidate token “cancer” having the probability value of 0.21 in the first probability data 510).

The language processing apparatus may obtain frequency data 520 including frequencies of the candidate tokens matching each token by extracting a frequency of each token included in the token sequence 410. For example, as shown in FIG. 4, the language processing apparatus may extract the frequencies of the tokens “your” and “disease name is” included in the token sequence 410 “your disease name is,” and based on the extracted frequency of each token, the language processing apparatus may obtain, among the candidate tokens, the frequencies of the candidate tokens “your” and “disease name is” matching each token as 1.

The language processing apparatus may obtain second probability data 530 by adjusting a probability value for at least one of the candidate tokens based on the frequency of each token included in the token sequence 410. The language processing apparatus may adjust the probability values for the candidate tokens included in the first probability data 510 to be smaller as the frequencies of the candidate tokens included in the frequency data 520 increase. For example, the language processing apparatus may adjust the probability values for the candidate tokens “your” and “disease name is,” which have relatively high frequencies, to be smaller than the existing probability values.

The language processing apparatus may obtain the second probability data 530 by adjusting, among the candidate tokens, a probability value for at least one of the remaining candidate tokens, excluding a special token and some designated candidate tokens, based on the frequency of each token included in the token sequence 410. For example, when a user is Korean, the user may not understand the processing result of the language processing apparatus, which is output in English, so the candidate token “cancer” 516 may be included in one of some designated candidate tokens depending on the user environment. The second probability data 530 may be obtained based on the first probability data 510 and the frequency data 520. The sum of the probability values for the candidate tokens included in the second probability data 450 may be 1. The second probability data 530 may be obtained by fixing the probability value 514 for the EOS token 512 and the probability value 518 for the candidate token “cancer” 516 in the first probability data 510 and adjusting the probability value for at least one of the remaining candidate tokens, excluding the EOS token 512 and the candidate token “cancer” 516. The language processing apparatus may adjust the probability value for at least one of the remaining candidate tokens, excluding the EOS token 512 and the candidate token “cancer” 516, such that a probability value 534 for an EOS token 532 and a probability value 538 for a candidate token “cancer” 536 included in the second probability data 530 are the same as the probability value 514 for the EOS token 512 and the probability value 518 for the candidate token “cancer” 516 included in the first probability data 510.

For example, the probability value for the candidate token “your” included in the second probability data 530 may be 0.09, the probability value for the candidate token “disease name is” may be 0.2, the probability value for the candidate token “cancer” may be 0.41, the probability value 534 for the EOS token 532 may be 0.19, and the probability value 538 for the candidate token “cancer” 536 may be 0.11. Comparing the first probability data 510 with the second probability data 530, it may be seen that the probability value for the candidate token “cancer” to be output following the token sequence 410 “your disease name is” increases from 0.21 to 0.41, the probability value for the candidate token “your” decreases from 0.19 to 0.09, and the probability value for the candidate token “disease name is” decreases from 0.3 to 0.2, while the probability value for the EOS token and the probability value for the candidate token “cancer” remain unchanged as 0.19 and 0.11, respectively. As a result, the probability value 534 for the EOS token 532 and the probability value 538 for the candidate token “cancer” 536 included in the second probability data 530 may be the same as the probability value 514 for the EOS token 512 and the probability value 518 for the candidate token “cancer” 516 included in the first probability data 510.

The language processing apparatus may lower the probability that the same token is repeated and determined to be a target token by adjusting the probability values for the candidate tokens matching each token included in the token sequence 410 to be small. The language processing apparatus may maintain the length of the output processing result as the probability value 514 for the EOS token 512 included in the first probability data 510 is fixed, that is, as the probability value that the EOS token 532 indicating the end of a sequence is determined to be the target token is maintained. The language processing apparatus may generate the processing result considering the user environment by increasing the probability that the remaining candidate tokens, excluding some designated candidate tokens, are determined to be the target tokens as the probability value 518 for the candidate token “cancer” 516 included in the first probability data 510 is fixed, that is, as the probability value that the candidate token “cancer” 536, which is one of some designated candidate tokens, is determined to be the target token is maintained.

FIG. 6 illustrates an example of configurations of a language processing apparatus.

Referring to FIG. 6, the language processing apparatus 600 may include a processor 610 (e.g., one or more processors), a memory 620 (e.g., one or more memories), and an input/output interface 630. Each component of the language processing apparatus 600 may communicate with each other via a communication bus 640. Some of the components may be omitted from the language processing apparatus 600, and/or another component may be added to the language processing apparatus 600. The language processing apparatus 600 may correspond to the language processing apparatus (e.g., the language processing apparatus 100 of FIG. 1) described herein.

The processor 610 may control another component (e.g., a hardware or software component) of the language processing apparatus 600 and perform a variety of data processing or computation. As at least part of data processing or computation, the processor 610 may store instructions or data received from another component in the memory 620, process the instructions or data stored in the memory 620, and store result data in the memory 620. The processor 610 may include a main processor (e.g., a central processing unit (CPU) or an application processor (AP)) or an auxiliary processor (e.g., a graphics processing unit (GPU), a neural processing unit (NPU), an image signal processor (ISP), a sensor hub processor, and/or a communication processor (CP)) that is operable independently of or in conjunction with the main processor.

The processor 610 may generate a token sequence by preprocessing input data, obtain first probability data including a probability value for each of a plurality of candidate tokens by inputting the token sequence to a GLM, obtain second probability data by adjusting a probability value for at least one of the candidate tokens based on a frequency of each token included in the token sequence, and determine, among the candidate tokens, a target token to be combined with the token sequence based on the second probability data.

The processor 610 may obtain frequencies of the candidate tokens matching each token by extracting the frequency of each token included in the token sequence. The processor 610 may adjust the probability values for the candidate tokens included in the first probability data to be smaller as the frequencies of the candidate tokens matching each token included in the token sequence increase.

The processor 610 may obtain the second probability data by adjusting, among the candidate tokens, a probability value for at least one of the remaining candidate tokens, excluding a special token, based on the frequency of each token included in the token sequence. A probability value for the special token included in the second probability data may be the same as a probability value for the special token included in the first probability data. The processor 610 may obtain the second probability data by adjusting, among the candidate tokens, the probability value for at least one of the remaining candidate tokens, excluding the special token and some designated candidate tokens, based on the frequency of each token included in the token sequence. The probability values for the special token and some designated candidate tokens included in the second probability data may be the same as probability values for the special token and the some designated candidate tokens included in the first probability data.

The memory 620 may store instructions executable by the processor 610. When executed by the processor 610, the instructions executable by the processor 610 may cause the processor 610 to perform operations of a language processing method. For example, the memory 620 may be or include a non-transitory computer-readable storage medium storing code that, when executed by the processor 610, configures the processor 610 to perform any one, any combination, or all of the operations and/or methods disclosed herein with reference to FIGS. 1-6. The memory 620 may be integrated with the processor 610. For example, random-access memory (RAM) or flash memory may be arranged in an integrated circuit (IC) microprocessor. In addition, the memory 620 may include a separate device, such as a storage device that may be used by an external disk drive, a storage array, and/or a database system. The memory 620 and the processor 610 may be operatively integrated or may communicate with each other through a network connection such that the processor 610 may read a file stored in the memory 620. The memory 620 may be a computer-readable storage medium that stores instructions.

Examples of a non-transitory computer-readable storage medium may include read-only memory (ROM), programmable ROM (PROM), electrically erasable programmable ROM (EEPROM), RAM, dynamic RAM (DRAM), static RAM (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, a hard disk drive (HDD), a solid-state drive (SSD), a card memory (e.g., a multimedia card, a secure digital (SD) card, and/or an extreme digital (XD) card), magnetic tape, a floppy disk, a magneto-optical data storage device, an optical data storage device, a hard disk, a solid-state disk, and other devices.

The input/output interface 630 may include one of a high-definition multimedia interface (HDMI), a mobile high-definition link (MHL), a universal serial bus (USB), a display port (DP), a Thunderbolt, a video graphics array (VGA) port, a red, green, and blue (RGB) port, D-subminiature (D-SUB), and a digital visual interface (DVI).

The input/output interface 630 may include an input interface (e.g., a touch screen or a microphone) for receiving control instructions or information from a user and an output interface (e.g., a display panel or a speaker) for displaying the execution result of an operation under the control of the user or the processing result of the language processing apparatus 600.

A method of processing a language input may include generating a token sequence by preprocessing input data, obtaining first probability data including probability values for a plurality of candidate tokens by inputting the token sequence to a generative language model (GLM), in which the first probability data includes a probability value for a special token, obtaining second probability data by adjusting a probability value for at least one of the candidate tokens based on a frequency of each token included in the token sequence, and determining, among the candidate tokens, a target token to be combined with the token sequence based on the second probability data, in which the probability value for the special token included in the first probability data is the same as a probability value for the special token included in the second probability data.

The obtaining of the second probability data may include obtaining frequencies of the candidate tokens matching the each token included in the token sequence by extracting the frequency of the each token included in the token sequence.

The obtaining of the second probability data may include adjusting the probability values for the candidate tokens included in the first probability data to be smaller as the frequencies of the candidate tokens matching the each token included in the token sequence increase.

The obtaining of the second probability data may include obtaining the second probability data by adjusting, among the candidate tokens, a probability value for at least one of the remaining candidate tokens, excluding the special token, based on the frequency of the each token included in the token sequence.

The special token may include at least one of a token indicating an end of a sequence, a token indicating an end of a document, a token indicating an end of text, a token indicating an end of a turn, and/or a token indicating an end of a task.

Probability values for some designated candidate tokens among the candidate tokens included in the second probability data may be the same as probability values for the some designated candidate tokens included in the first probability data.

The obtaining of the second probability data may include obtaining the second probability data by adjusting, among the candidate tokens, a probability value for at least one of the remaining candidate tokens, excluding the special token and the some designated candidate tokens, based on the frequency of the each token included in the token sequence.

Probability values for some designated candidate tokens among the candidate tokens included in the second probability data may be smaller than probability values for the some designated candidate tokens included in the first probability data.

An apparatus for processing a language input may include a memory configured to store instructions and at least one processor configured to execute the instructions, in which the at least one processor is configured to generate a token sequence by preprocessing input data, obtain first probability data including probability values for a plurality of candidate tokens by inputting the token sequence to a GLM, in which the first probability data includes a probability value for a special token, obtain second probability data by adjusting a probability value for at least one of the candidate tokens based on a frequency of each token included in the token sequence, and determine, among the candidate tokens, a target token to be combined with the token sequence based on the second probability data, in which the probability value for the special token included in the first probability data is the same as a probability value for the special token included in the second probability data.

The at least one processor may be configured to obtain frequencies of the candidate tokens matching the each token by extracting the frequency of the each token included in the token sequence.

The at least one processor may be configured to adjust the probability values for the candidate tokens included in the first probability data to be smaller as the frequencies of the candidate tokens matching the each token included in the token sequence increase.

The at least one processor may be configured to obtain the second probability data by adjusting, among the candidate tokens, a probability value for at least one of the remaining candidate tokens, excluding the special token, based on the frequency of the each token included in the token sequence.

The at least one processor may be configured to obtain the second probability data by adjusting, among the candidate tokens, a probability value for at least one of the remaining candidate tokens, excluding the special token and the some designated candidate tokens, based on the frequency of the each token included in the token sequence.

The language processing apparatuses, smartphones, microphones, computers, encoders, decoders, processors, memories, input/output interfaces, communication buses, language processing apparatus 100, smartphone 110, microphone 112, computer 114, encoder 320, decoder 350, language processing apparatus 600, processor 610, memory 620, input/output interface 630, and communication bus 640 described herein, including descriptions with respect to respect to FIGS. 1-6, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-6 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method comprising:
generating a token sequence by preprocessing input data;
generating first probability data comprising probability values for candidate tokens by inputting the token sequence to a generative language model (GLM), wherein the first probability data comprises a probability value for a special token;
generating second probability data by adjusting a probability value for one or more of the candidate tokens based on a frequency of each of tokens comprised in the token sequence; and
determining, among the candidate tokens, a target token to be combined with the token sequence based on the second probability data,
wherein the probability value for the special token is excluded from the adjusting such that the probability value for the special token comprised in the first probability data is the same as a probability value for the special token comprised in the second probability data.

2. The method of claim 1, wherein the generating of the second probability data comprises, for each of the candidate tokens matching a respective token comprised in the token sequence, generating a frequency of the candidate token by extracting the frequency of the respective token comprised in the token sequence.

3. The method of claim 2, wherein the generating of the second probability data comprises, for each of the candidate tokens matching the respective token comprised in the token sequence, adjusting the probability value for the candidate token comprised in the first probability data to be smaller as the frequency of the candidate token matching the respective token comprised in the token sequence increases.

4. The method of claim 2, wherein the generating of the second probability data comprises, for each of the candidate tokens matching the respective token comprised in the token sequence, adjusting the probability value for the candidate token comprised in the first probability data inversely proportional to the frequency of the candidate token.

5. The method of claim 1, wherein the generating of the second probability data comprises generating the second probability data by adjusting, among the candidate tokens, a probability value for one or more of remaining candidate tokens, excluding the special token, based on the frequencies of the tokens comprised in the token sequence.

6. The method of claim 1, wherein the special token comprises any one or any combination of any two or more of a token indicating an end of a sequence, a token indicating an end of a document, a token indicating an end of text, a token indicating an end of a turn, and a token indicating an end of a task.

7. The method of claim 1, wherein probability values for one or more designated candidate tokens among the candidate tokens comprised in the second probability data are the same as probability values for the one or more designated candidate tokens comprised in the first probability data.

8. The method of claim 6, wherein the generating of the second probability data comprises generating the second probability data by adjusting, among the candidate tokens, a probability value for one or more of remaining candidate tokens, excluding the special token and the one or more designated candidate tokens, based on the frequency of the each token comprised in the token sequence.

9. The method of claim 1, wherein probability values for one or more designated candidate tokens among the candidate tokens comprised in the second probability data are smaller than probability values for the one or more designated candidate tokens comprised in the first probability data.

10. The method of claim 9, wherein the generating of the second probability data comprises generating the second probability data by adjusting, among the candidate tokens, a probability value for one or more of remaining candidate tokens, excluding the special token, based on the frequency of the each token comprised in the token sequence.

11. A non-transitory computer-readable storage medium storing code that, when executed by one or more processors, configures the one or more processors to perform the method of claim 1.

12. An apparatus comprising:
one or more processors configured to:
generate a token sequence by preprocessing input data;
generate first probability data comprising probability values for candidate tokens by inputting the token sequence to a generative language model (GLM), wherein the first probability data comprises a probability value for a special token;
generate second probability data by adjusting a probability value for one or more of the candidate tokens based on a frequency of each token comprised in the token sequence; and
determine, among the candidate tokens, a target token to be combined with the token sequence based on the second probability data,
wherein the probability value for the special token is excluded from the adjusting such that the probability value for the special token comprised in the first probability data is the same as a probability value for the special token comprised in the second probability data.

13. The apparatus of claim 12, wherein, for the generating of the second probability data, the one or more processors are configured to, for each of the candidate tokens matching a respective token comprised in the token sequence, generate a frequency of the candidate token by extracting the frequency of the respective token comprised in the token sequence.

14. The apparatus of claim 13, wherein, for the generating of the second probability data, the one or more processors are configured to, for each of the candidate tokens matching the respective token comprised in the token sequence, adjust the probability value for the candidate token comprised in the first probability data to be smaller as the frequency of the candidate token matching the respective token comprised in the token sequence increases.

15. The apparatus of claim 12, wherein, for the generating of the second probability data, the one or more processors are configured to generate the second probability data by adjusting, among the candidate tokens, a probability value for one or more of remaining candidate tokens, excluding the special token, based on the frequencies of the tokens comprised in the token sequence.

16. The apparatus of claim 12, wherein the special token comprises any one or any combination of any two or more of a token indicating an end of a sequence, a token indicating an end of a document, a token indicating an end of text, a token indicating an end of a turn, and a token indicating an end of a task.

17. The apparatus of claim 12, wherein probability values for one or more designated candidate tokens among the candidate tokens comprised in the second probability data are the same as probability values for the one or more designated candidate tokens comprised in the first probability data.

18. The apparatus of claim 17, wherein, for the generating of the second probability data, the one or more processors are configured to generate the second probability data by adjusting, among the candidate tokens, a probability value for one or more of remaining candidate tokens, excluding the special token and the one or more designated candidate tokens, based on the frequency of the each token comprised in the token sequence.

19. The apparatus of claim 12, wherein probability values for one or more designated candidate tokens among the candidate tokens comprised in the second probability data are smaller than probability values for the one or more designated candidate tokens comprised in the first probability data.

20. The apparatus of claim 12, wherein, for the generating of the second probability data, the one or more processors are configured to generate the second probability data by adjusting, among the candidate tokens, a probability value for one or more of remaining candidate tokens, excluding the special token, based on the frequency of the each token comprised in the token sequence.
